(19) United States
(12) Patent Application Publication
(10) Pub. No.: US 2014/0114884 A1
(43) Pub. Date: Apr. 24, 2014

(54) System and Method for Providing Wardrobe Assistance

(71) Applicant: Dhiraj Daway, Plainsboro, NJ (US)

(72) Inventor: Dhiraj Daway, Plainsboro, NJ (US)

(21) Appl. No.: 13/989,408

(22) PCT Filed: Nov. 24, 2011
(86) PCT No.: PCT/US11/62152

§ 371 Date: Dec. 26, 2013

Related U.S. Application Data
(60) Provisional application No. 61/417,145, filed on Nov. 24, 2010.

(51) Int. Cl. G06N 5/02

(52) U.S. Cl. CPC G06N 5/02
USPC 706/11

(57) ABSTRACT

A system and method for suggesting clothing options based on one or more of weather, geographic location, social network friend suggestions, community suggestions, user's wardrobe, and event or dress code is provided. The system and method is preferably implemented by a web based social network community and website. Furthermore, the system and method can assist is shopping an trading of wardrobe items.

### CROSS-REFERENCE TO RELATED APPLICATIONS

This application claims priority to and benefit of U.S. Provisional Patent Application No. 61/417,145, filed Nov. 24, 2010 and entitled “Social Network Web-site to Suggest What to Wear”, the disclosure of which is incorporated by reference herein in its entirety.

### BACKGROUND

The problem of what to wear to a particular function, event, meeting or location (e.g. the workplace, restaurants or parties) is a question that everyone deals with daily. For example, the particular function could be going to work or school every day, having an outdoor lunch or a formal party. The way most of people decide this now is by checking the weather, asking friends for suggestions, finding out what everyone else is wearing to the particular event or by browsing through fashion websites and magazines to get a feel of what is popular for particular functions. Thus, the clothing chosen is dependent on the latest products from the vendors, weather, location, dress code and suggestions from others.

For example, deciding “what to wear?” is one of the first questions that comes to mind every morning. People struggle to find the latest fashion trends and often browse through several websites to find the latest ideas. Currently there are few viable solutions to assist people in obtaining and implementing a wardrobe that provides clothing options for a broad spectrum of uses. What is needed is a system and method that provides users with what they should wear depending on weather conditions, event and suggestions from friends or professional advisors in a user's social network.

### SUMMARY OF THE INVENTION

In view of the foregoing limitations, associated with the use of traditional technology, a method and a system is presented for suggesting clothing options to users. Accordingly, the present invention provides a system and method for suggesting clothing options to users based on a variety or criteria further described herein.

Accordingly in an aspect of the present invention, a system and method for suggesting clothing options based on one or more of weather, geographic location, social network friend suggestions, community suggestions, user's wardrobe, and event or dress code. In a further aspect this includes a web based community and website to implement the system and method.

In a further aspect of the present invention, an algorithm (sometimes referred to as the “Suggestion Algorithm”) determines the fashion product (e.g. shirt blouse, pants, skirt, dress or other clothing, or accessories such as footwear, headwear, glasses, gloves or jewelry) to suggest based on one or more of the following: weather, zip code or other geographic indicia of the event location, suggestions from friends in the user's network, the latest fashion products added by the user community of the website, the user's wardrobe, if maintained online on the website, and the type of event or dress code for an occasion.

In another aspect of the present invention, users may setup their own wardrobe on the website and receive suggestions from both their wardrobe and a database of products.

In yet another aspect of the present invention, users may obtain suggestions on proposed outfits or their wardrobes from friends which are also members of a social network community implementing aspects of the present invention.

In a still further aspect of the present invention, users are able to purchase clothing and accessories suggested by the website from either another online retailer or the website itself.

### BRIEF DESCRIPTION OF THE DRAWINGS

FIG. 1 demonstrates an exemplary suggestion matrix table which is used to determine what to suggest to the user.

FIG. 2 demonstrates an exemplary latest color table which is used to determine the latest color(s) in fashion for a particular category of fashion product.

FIG. 3 demonstrates an exemplary latest material table which is used to determine the latest textile or other material(s) for the fashion product. Example: During summer the latest material table will contain materials like cotton, linen for a category “men-top-shirts/tees”.

FIG. 4 demonstrates an exemplary latest style table which is used to determine the latest style for the particular category of fashion product.

FIG. 5 is a demonstration of an algorithm in pseudo code to create a suggestion list for the user.

FIGS. 6A and B are flow charts of methods of the present invention for making suggestions to the user.

FIG. 7 demonstrates an exemplary home page for user registration and an exemplary get suggestion function for a non-registered user.

FIG. 8 is a demonstration of an exemplary user login process.

FIG. 9 is a demonstration of an exemplary user profile page on the site.

FIG. 10: is a demonstration of an exemplary way for administrators of the website to update information to the website.

FIG. 11 is a demonstration of an exemplary way for an administrator of the website to maintain the users.

FIG. 12 is a demonstration of an exemplary way of adding/removing another user of the website as a user's friend.

FIG. 13 is a demonstration of an exemplary function allowing users to send messages to other users of the site.

FIG. 14 is an exemplary demonstration of suggestions from the website, users friends suggestions and suggestions from a user wardrobe followed by user's friends activity.

FIG. 15 is an exemplary demonstration of user's latest activities, maintaining user events and favorite fashion brands.

FIG. 16 is an exemplary demonstration of an exemplary user wardrobe and mix/match function. Users of the website are able to upload, browse and mix/match wardrobe items to create an outfit.

FIG. 17 is an exemplary demonstration of how a user can mix/match from suggestions. The suggestions from the site, user's friends and user's wardrobe are displayed for user to mix/match and create an outfit

FIG. 18 is an exemplary demonstration of how a user can get quick suggestions for a gender, zip code and dress code that are different than the user defaults.

FIG. 19 is an exemplary demonstration of how the fashion products are displayed for the users to browse. These products can be sorted/searched by dress code, season, brand, fit, style etc.

FIG. 20 is an exemplary demonstration of a user wish list which is able to be maintained and shared with the other users of the site.

FIG. 21 is a depiction of an exemplary product detail page displaying information about a product and providing options to the user to buy it from the site, direct to another site, add to the wardrobe/wish list and/or suggest the product to another user.

FIG. 22 is a depiction of an exemplary way to maintain product categories for one or more products.

FIG. 23 depicts an exemplary way in which a product is added to a product table for suggestion to the users.

FIG. 24 depicts an exemplary way in which products are matched to weather variables, dress codes and gender and an exemplary way for administrators to maintain product related information.

FIG. 25 depicts an exemplary webpage which demonstrates how an administrator of the site can add/update a product on the website.

FIG. 26 depicts an exemplary webpage which demonstrates how a user can create and maintain an event on the website.

FIG. 27 depicts an exemplary event detail page and way in which a user can add/update what they are wearing to an event and see what others are wearing to the event.

FIG. 28 depicts an exemplary event display for the user by date where user can search and select the event and go to an event detail page as depicted in FIG. 21.

FIG. 29 depicts an exemplary way in which a user can add/update products on the site.

FIG. 30 depicts an exemplary mobile application process.

### DETAILED DESCRIPTION

In the following detailed description of embodiments of the invention, numerous specific details are set forth in order to provide a thorough understanding of the embodiment of invention. However, it will be obvious to a person skilled in art that the embodiments of invention may be practiced with or without these specific details. In other instances methods, procedures and components known to persons of ordinary skill in the art have not been described in details so as not to unnecessarily obscure aspects of the embodiments of the invention.

Furthermore, it will be clear that the invention is not limited to these embodiments only. Numerous modifications, changes, variations, substitutions and equivalents will be apparent to those skilled in the art, without parting from the spirit and scope of the invention.

Subject to the following definitions, a detailed description of the present invention and its embodiments is set forth herein. Users are defined as people who are members of the website and/or use its services. Customers are defined as companies and department stores that manufacture and/or retail clothing and other fashion accessories such as Macys, Kenneth Cole, and The Gap.

In a preferred embodiment, fashion product suggestions are provided to the user based on gender, weather, dress code and other criteria described herein. The suggestions are sent to users using various forms of communication such as cell-phone SMS, email, magazine, web browser, multimedia feeds, mobile applications, and TV feeds. These suggestions are generated from one or more of a pre-defined Suggestion Algorithm, other users within the network (of a user) and fashion consultants. The software implementing the algorithm is based on weather variables, product variables and other variables described hereinbelow. Weather is defined by temperature, humidity, precipitation and other weather parameters. Products variable is defined by type, layers, color, material, thickness, style, textile pattern and other clothing parameters. The weather variables are available from many web sites and services, these services will be used to determine the current weather. As weather variables will change constantly, for example, a fashion product's temperature variable is defined using a temperature range (high-low). If the temperature for that day is within the range of the temperature defined for the product, then product would be suggested if it meets the other criteria (for example event, dress code).

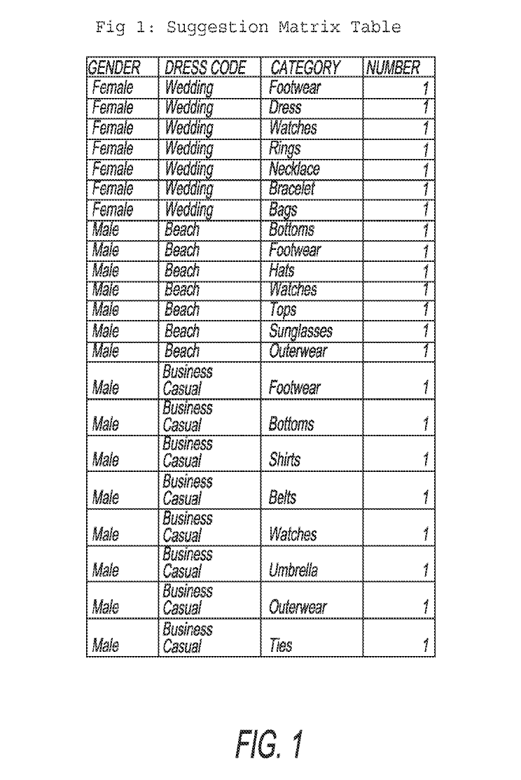

Preferably the Suggestion Algorithm is based on a suggestion matrix, for example as depicted in FIG. 1, that tells the system “what to suggest” based on selection criteria. Based on the list of products to suggest, the algorithm selects the products from the stored product table. The list of products is then further reduced by removing the insignificant product that does not match the user's selection criteria.

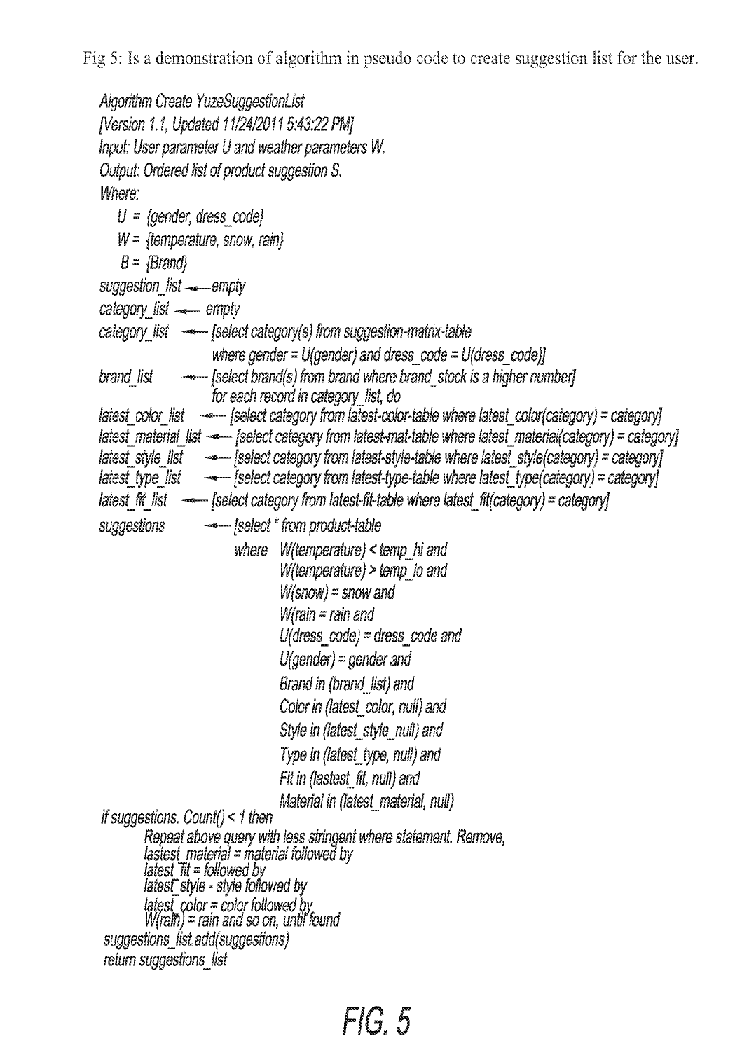

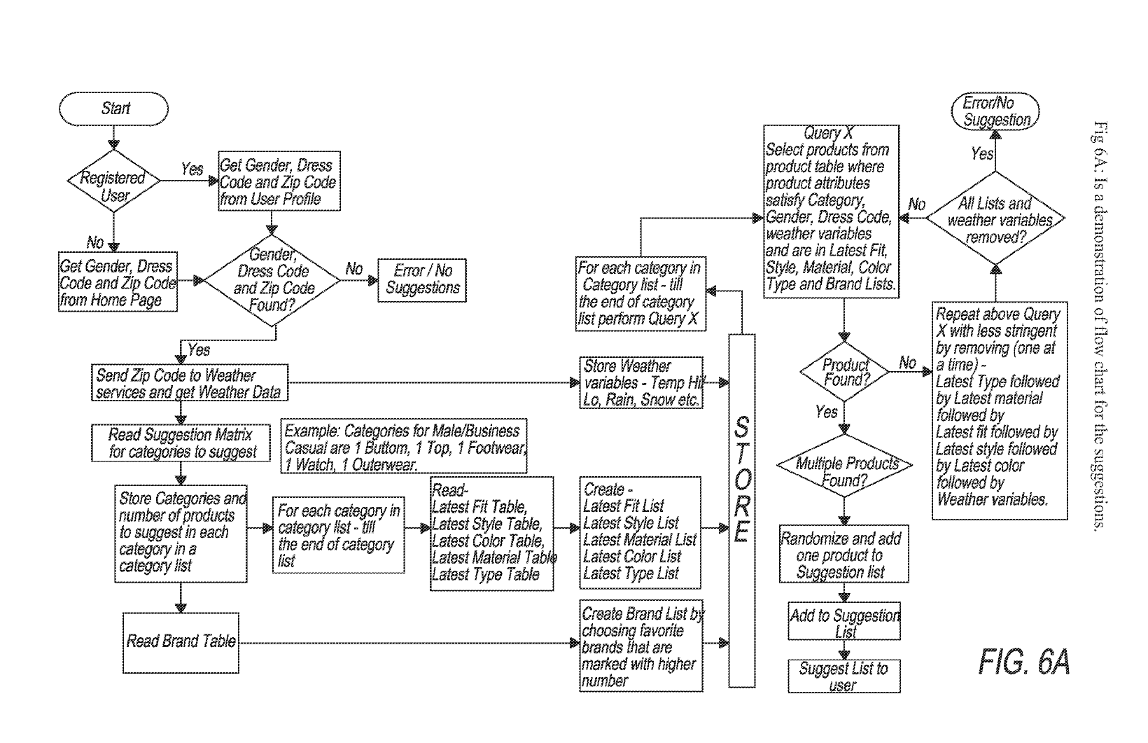

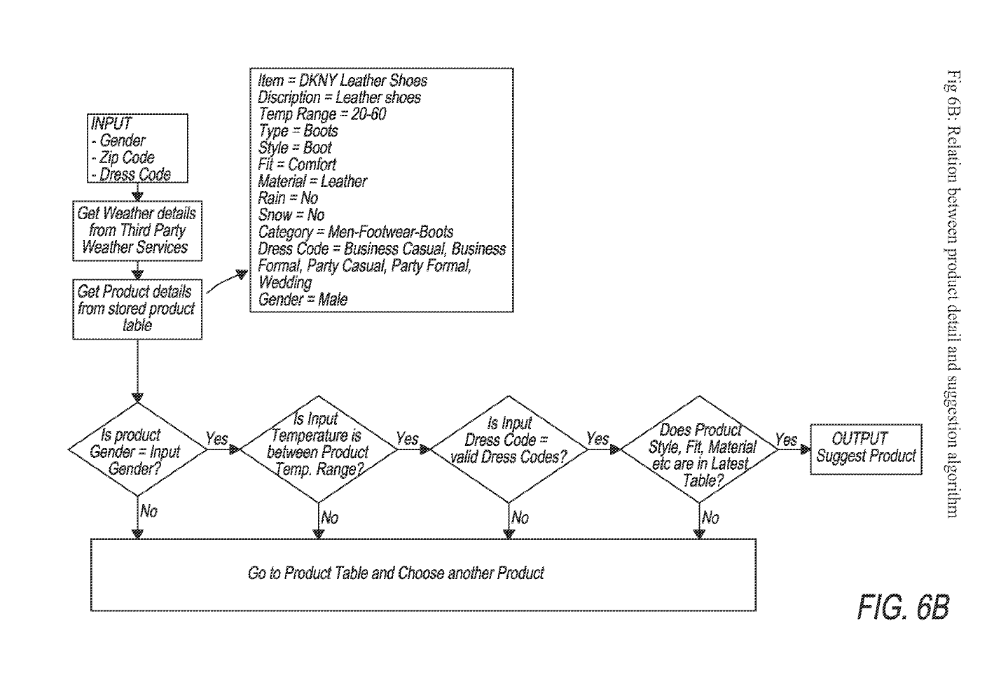

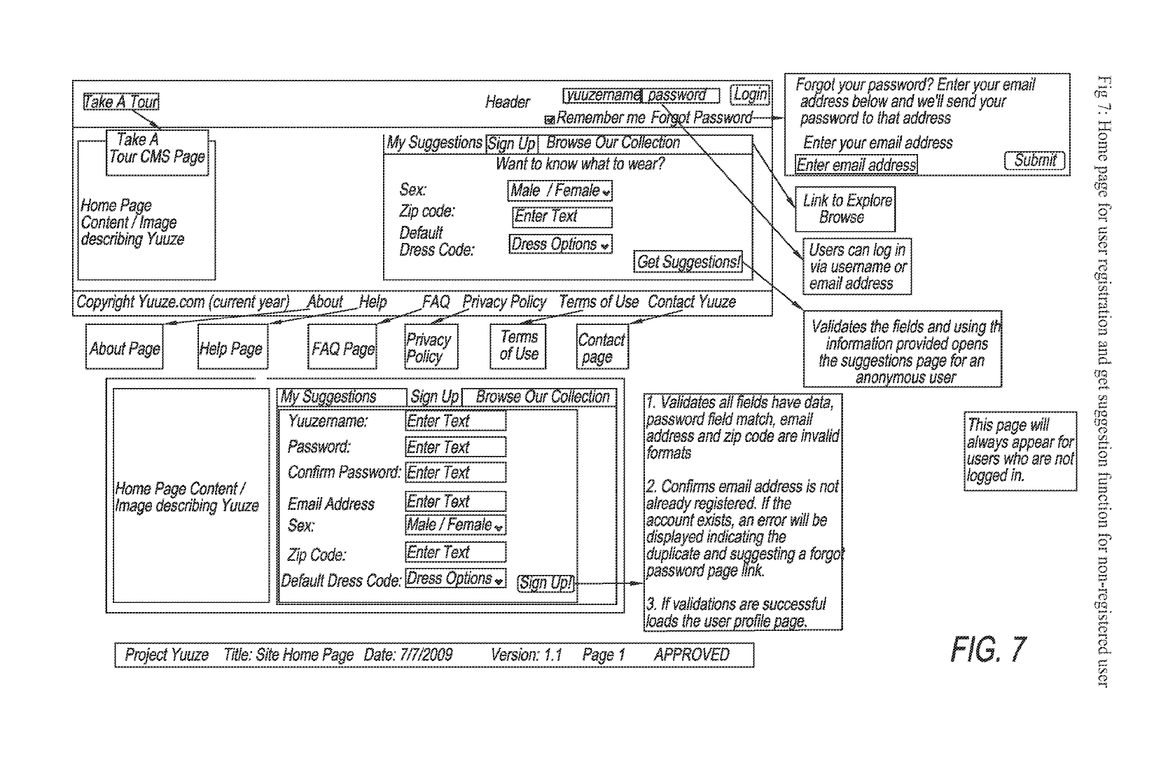

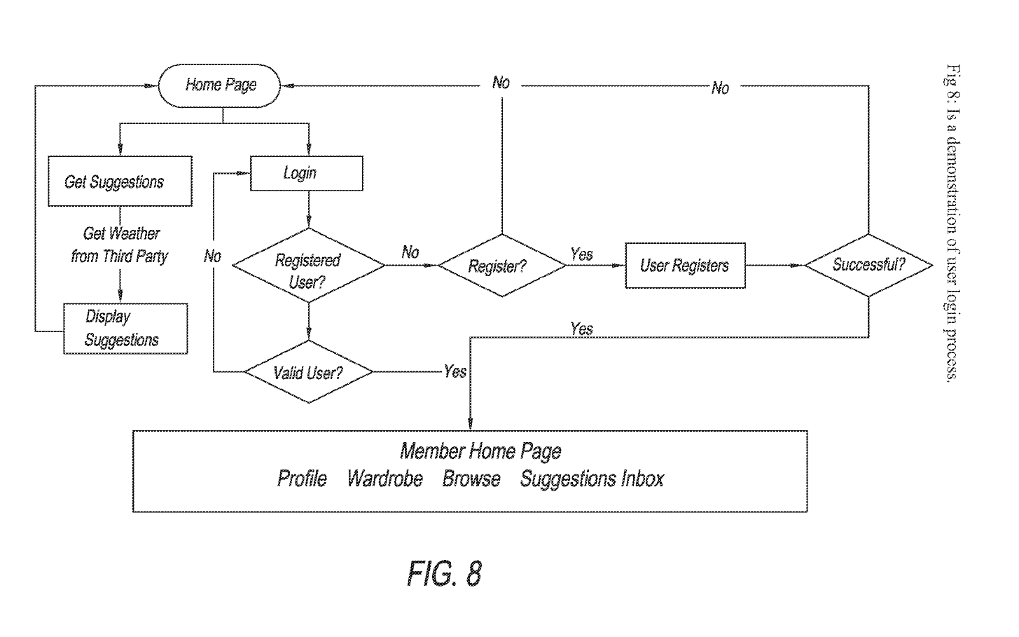

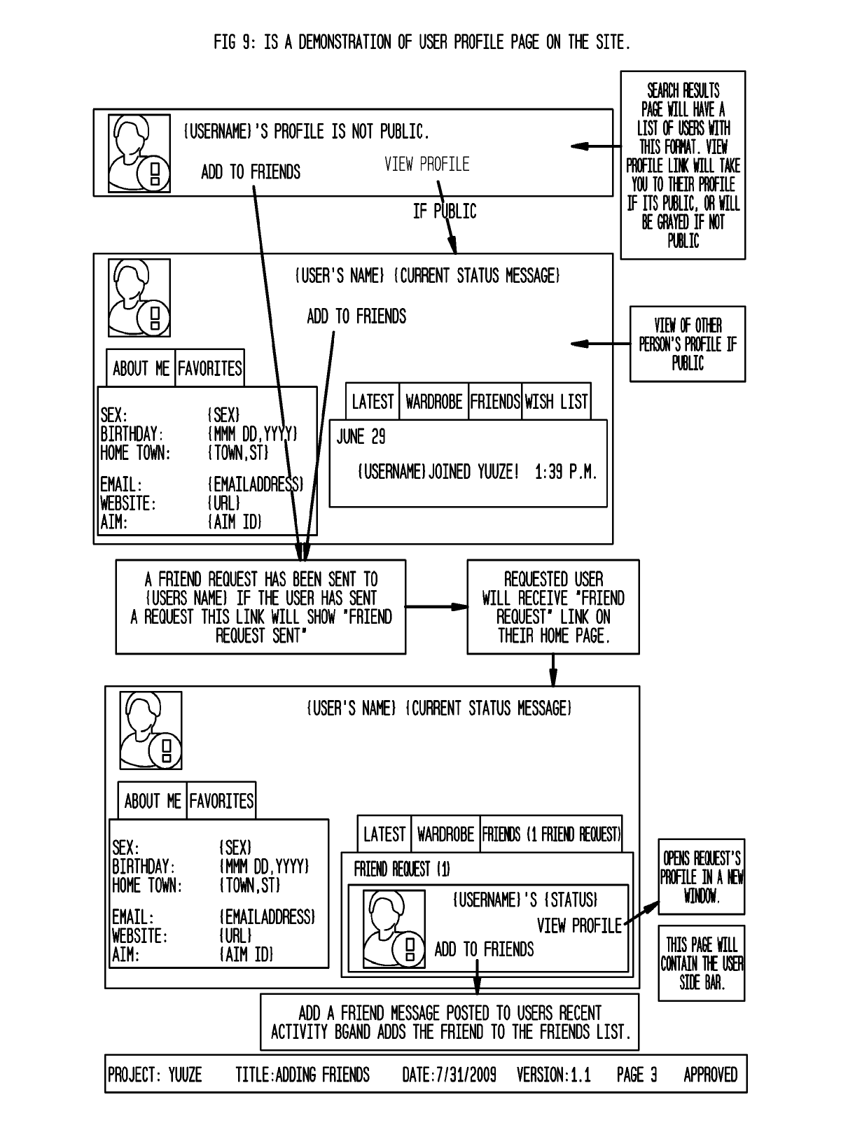

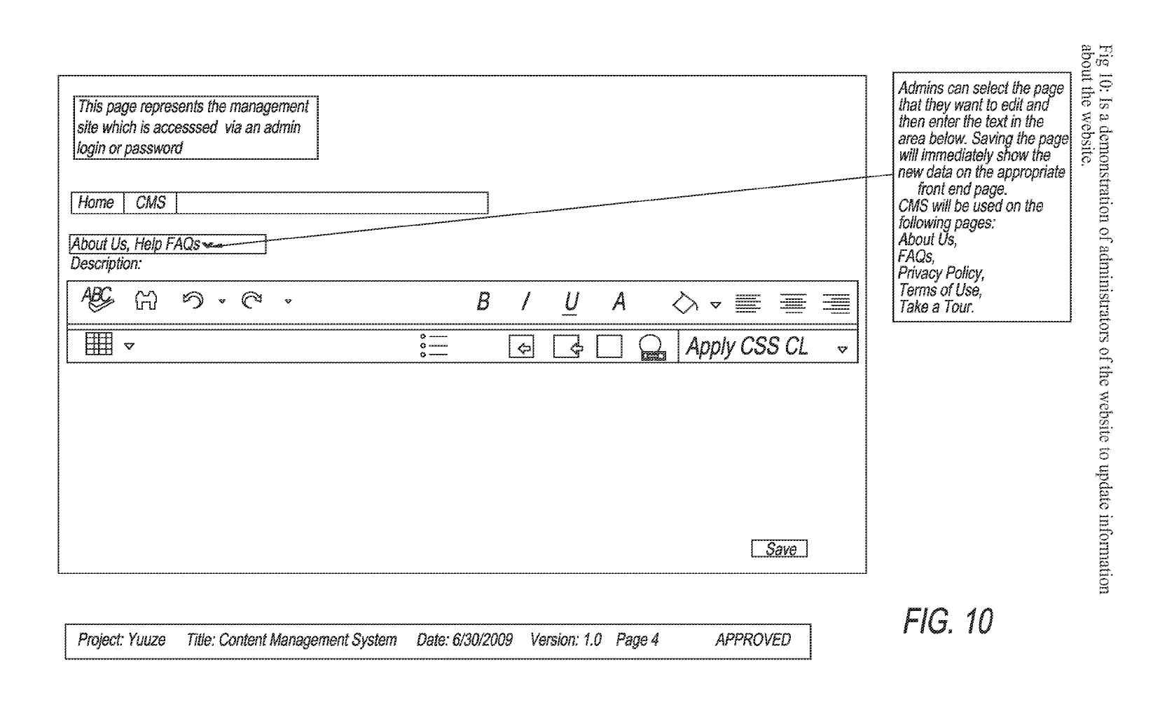

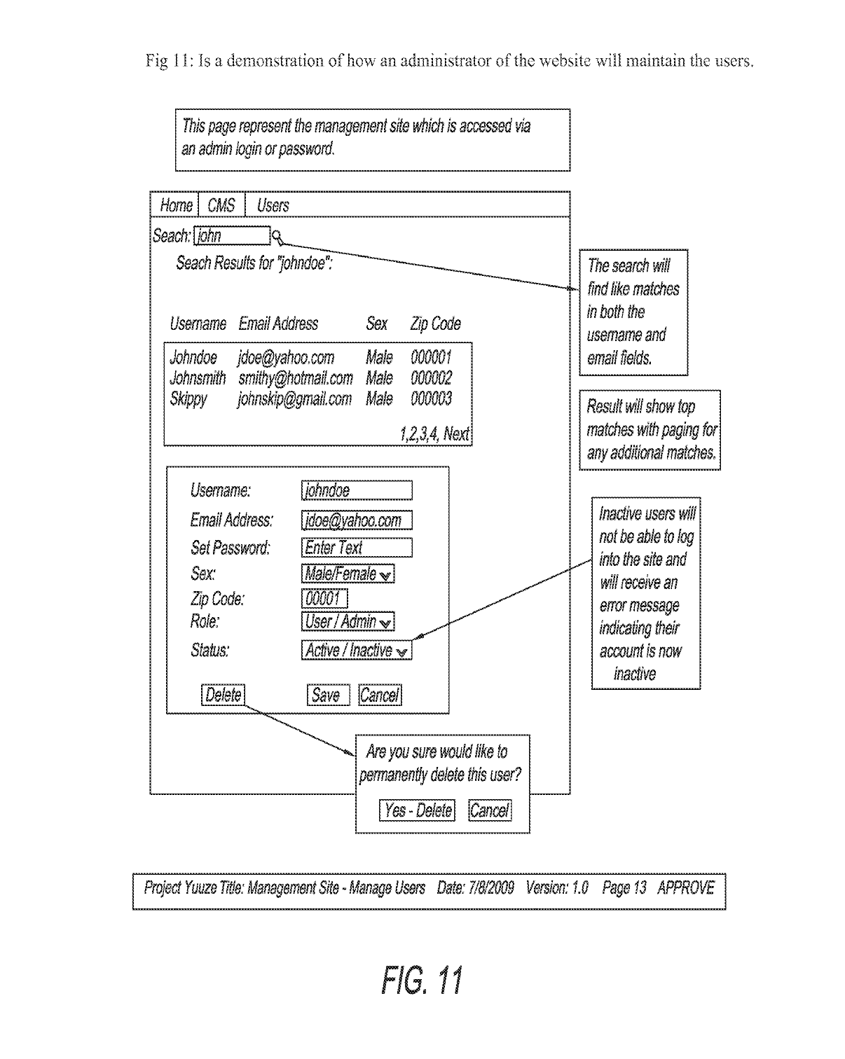

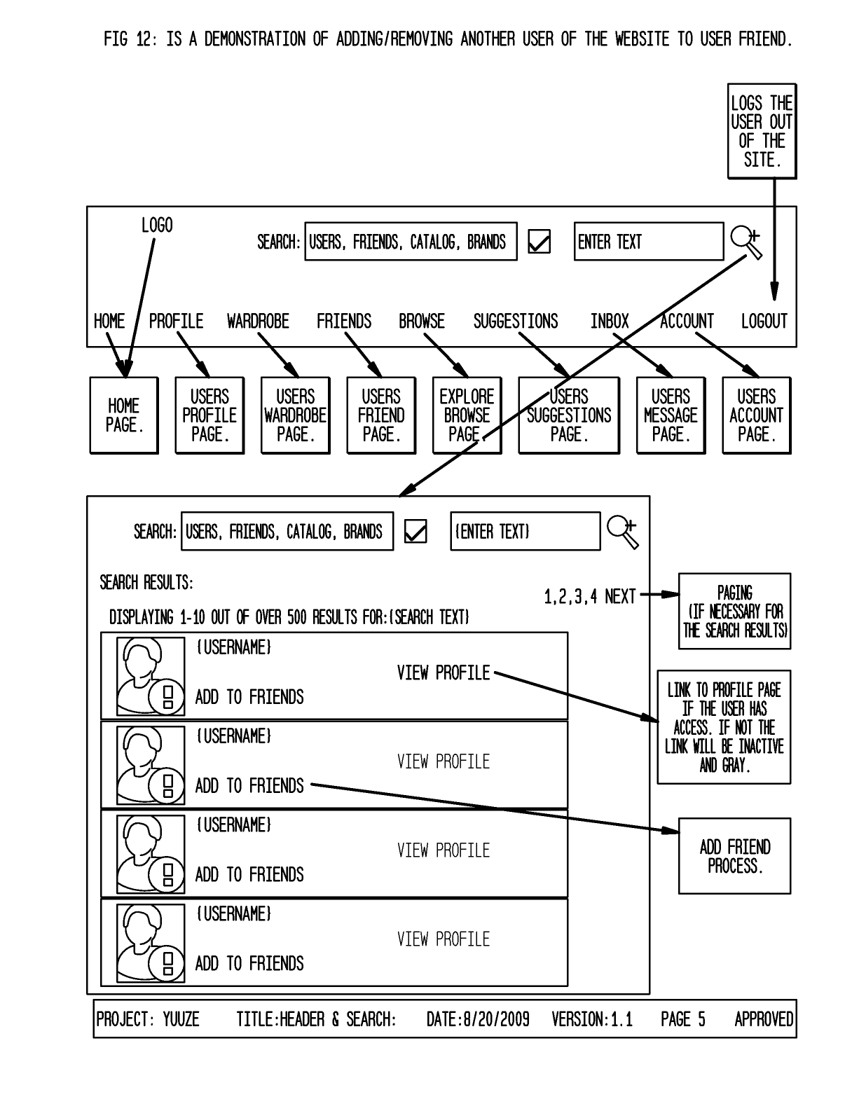

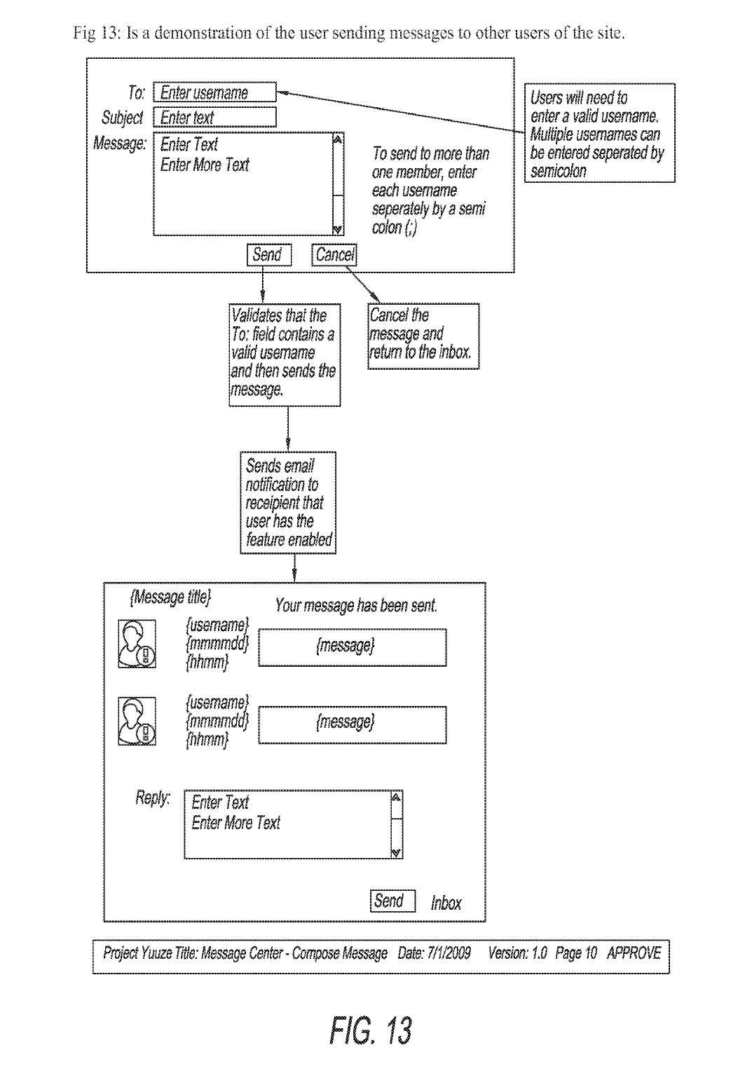

Preferably, the Suggestion Algorithm (FIG. 5) utilizes the parameters from FIG. 1-4 to determine the product to be suggested from the product table. The product table contains fashion product that may or may not relate to the user preference. Suggestion algorithm determines the product to be suggested by selecting relevant products and then repeatedly removing the less significant products from the list to arrive at a product to be suggested. This process is repeated until all categories of the product to be suggested are exhausted. The drawings of some of the Latest tables are provided herein and the invention allows for the use of many latest tables. Brand Table provides the most favorite brand by giving each brand in a table a Stock ID.

In one embodiment, fashion products are related to weather variables like temperature, rain/snow (precipitation). In further embodiments fashion products are related to variables for gender and dress code like male, female, business casual, business formal, wedding, sports, school wear, season (e.g. Spring, Fall, Winter or Summer) or any other dress code category which may be established within the system. The relationship between the fashion products and variables is created by either a manual or automatic process, or a combination of both. This relationship is utilized to suggest product to user based on the variables. For example, depending on a user input of gender, zip code and default dress code, the invention gets the weather in the zip code using, for example, a third party weather service and suggests fashion products relevant for the weather, dress code and gender to the user. Preferably, the zip code that is provided by the user is utilized as an input and the site then uploads weather data using a third party weather data provider and the provided zip code. The default zip code for the user is stored in the user profile on the website.

In a further embodiment, a system for getting suggestions at a pre-set time on a periodic basis is provided. The user creates a profile on the website and stores his/her gender, default dress code and zip code (or other geographic information) of the location. The user further sets the time he/she would like to receive suggestion. The suggestion algorithm then suggests products that matches with user's defaults and sends them via email or SMS or to a web application where they can be retrieved by the user. These communication channels can be expanded to get suggestions on a mobile device by utilizing a mobile application or by simply checking email or messages with the mobile device.

In yet another embodiment a mechanism for further characterizing the fashion products so that the products can be targeted to be worn for the condition and purpose they were designed and created for is provided. A suggestion matrix that is a collection of records in a table is utilized by the algorithm to let the system know what to suggest. For example, each gender and dress code lists a single or multiple item categories to be suggested. Further, when the algorithm resolves the product(s) to be suggested, it looks at product attributes and if they match with the user input and weather, those product(s) are suggested to the user.

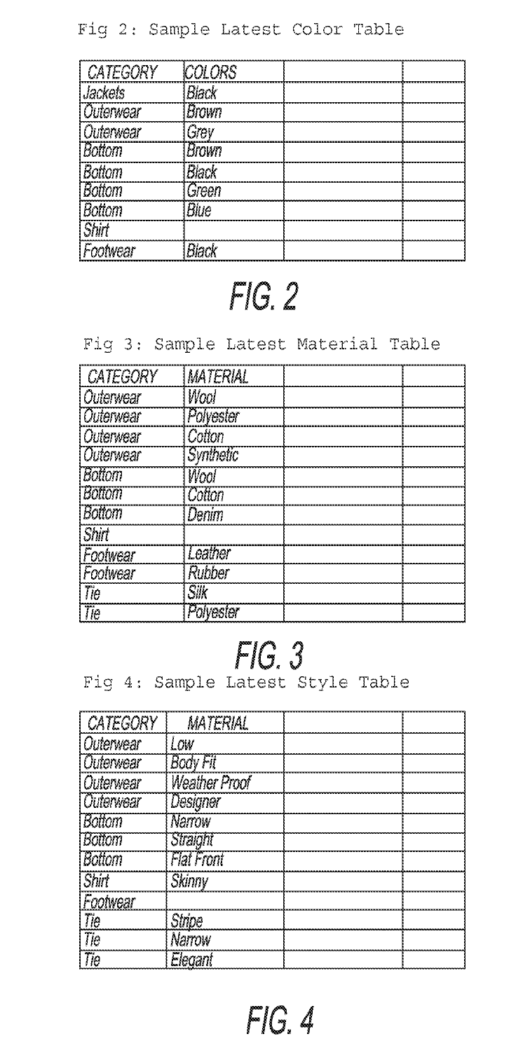

In embodiments of the present invention, the relationship between fashion products and the missing attributes like when the product can be used, what the product is designed for and what gender are provided. Also provided are updated or the latest tables that contain what is latest fit, style, color, material, type etc. (i.e. latest fashion), that is being currently used by fashion designers as latest fashion. The product to be suggested is matched up against the list of latest fashion and if the product attribute matches the latest fashion, it is suggested to the user. For example, the latest fashion is provided in the form of Latest tables (FIG. 2, FIG. 3 and FIG. 4). Exemplary tables are Latest Color, Latest Fit, Latest Material, Latest Style etc. These tables are used by an algorithm to determine if the product is currently in fashion. The latest tables are maintain by administrators of the website and are based on latest fashion trends.

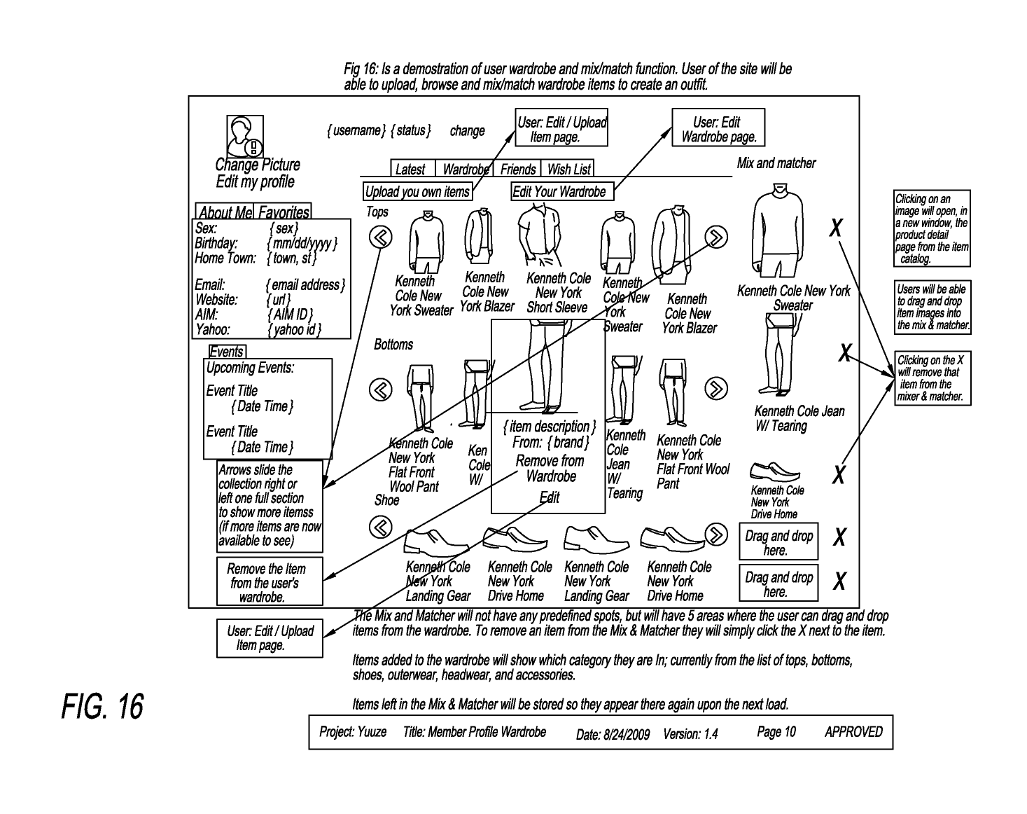

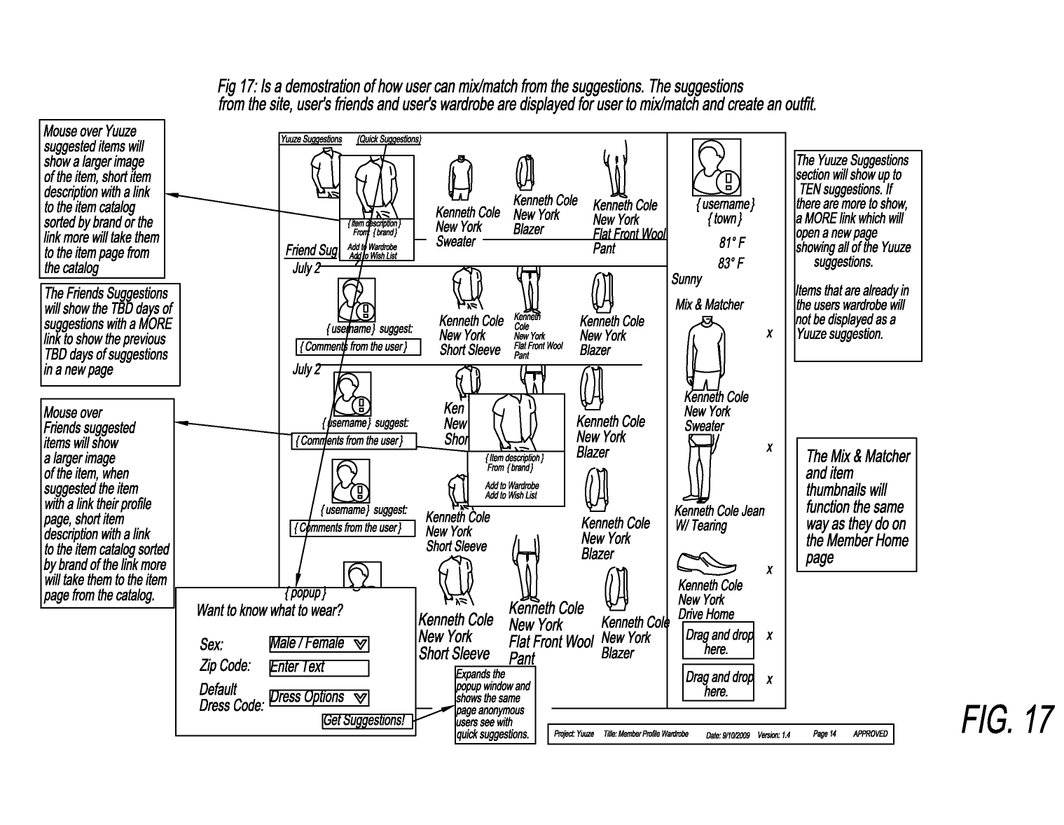

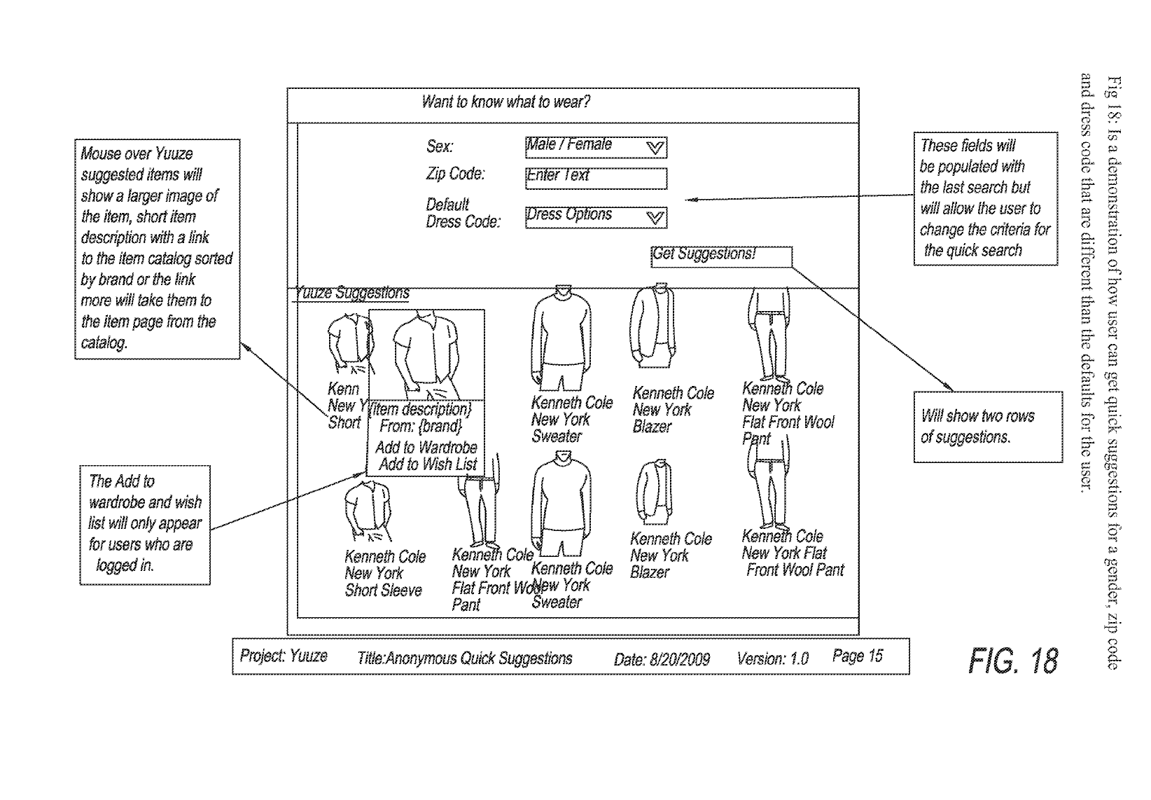

In still another embodiment, and in reference to FIG. 16, users may maintain their wardrobe online. The images of the products are uploaded by the user and placed in a proper category. The user has the ability to add/delete or update single or multiple products at a time in the wardrobe. The online wardrobe products are related to the gender, weather variables and dress code, based on user input and are suggested along with latest product. The online wardrobe can be made visible to user's friends on the website and allow friends to comment, allowing user to get friend suggestions on what to wear from the wardrobe. For example, a user's friends may send suggestions from the wardrobe and products on the website to the user as shown in FIG. 21.

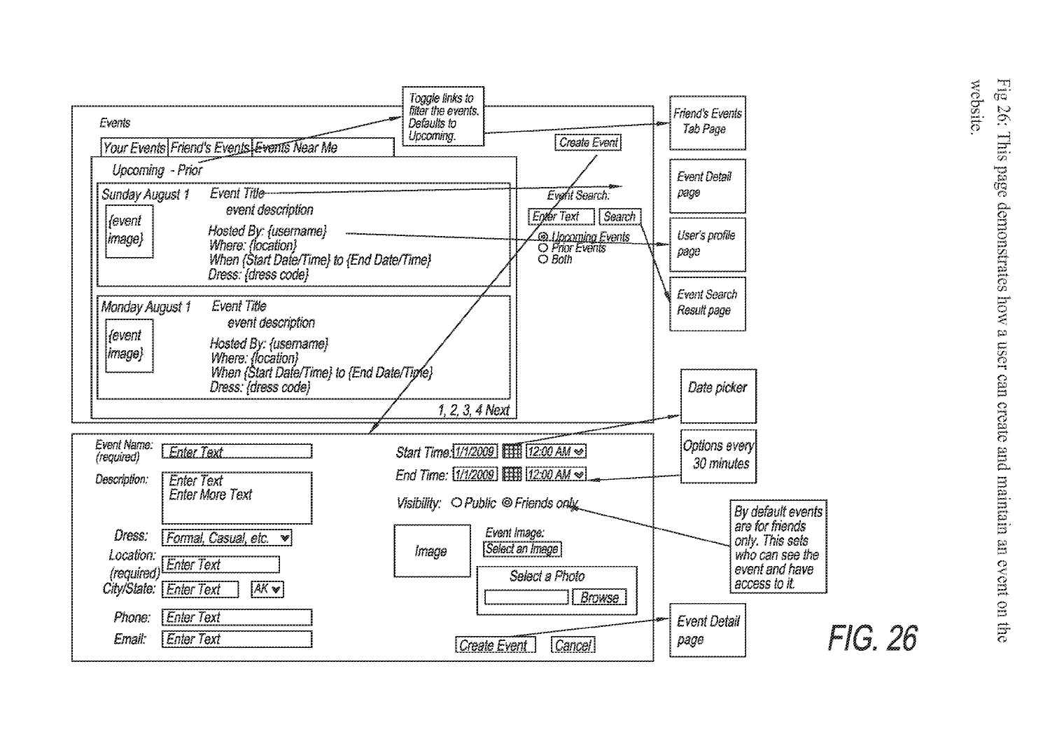

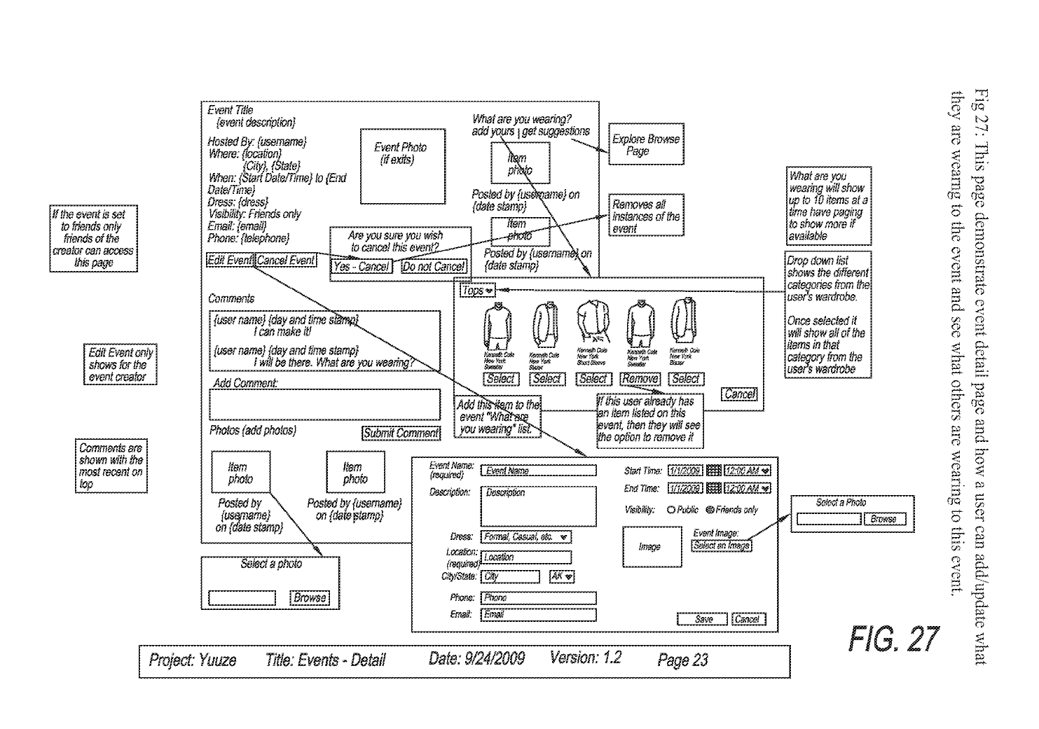

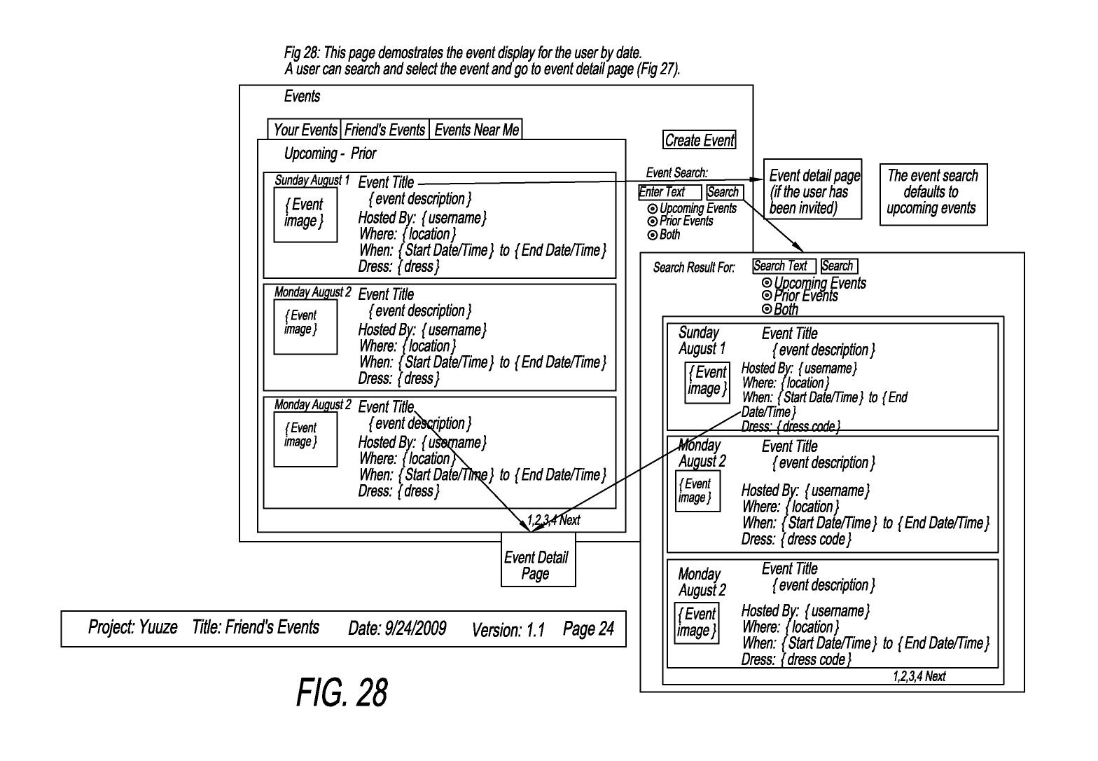

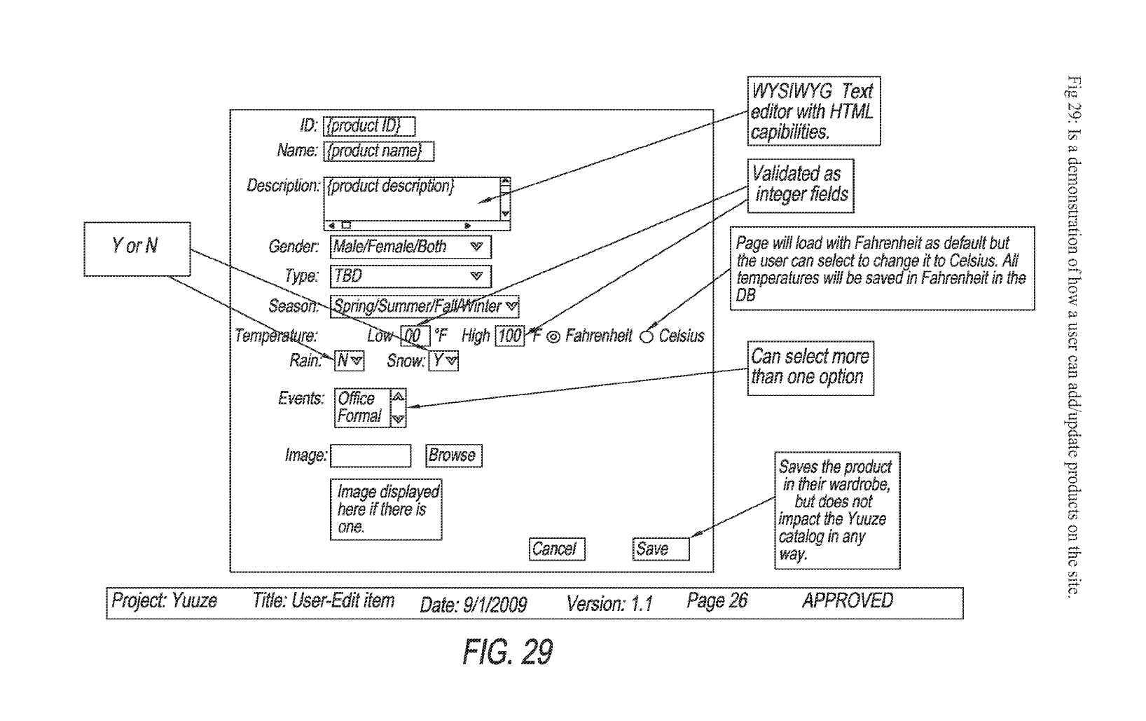

In another embodiment, users may create events and receive suggestions for products that they should wear to the event. The users can then upload clothes from their wardrobe that they are planning on wearing to the event. Referring now to FIG. 26, a user provides location, date and dress code for the event and receives suggestions on what to wear. A user may add what they will be wearing to the event and upload pictures of the event (FIG. 27). Users may invite others (either current or prospective users of the website) to the event. Users are able to enter comments for the event and browse events by date (FIG. 28).

In still another embodiment, users may build their friend circle by inviting other users of the site, or even nonusers who may then join the site, to be connected to their profile and view their suggestions, events and wardrobe. Still further, a user has the ability to keep a personal assistant and/or a personal shopper, allowing that shopper or assistant to work remotely. A user may simply add a personal assistant to his or her friends list, who has visibility to user wardrobe. The assistance than can pick the outfit for the user and send the suggestion.

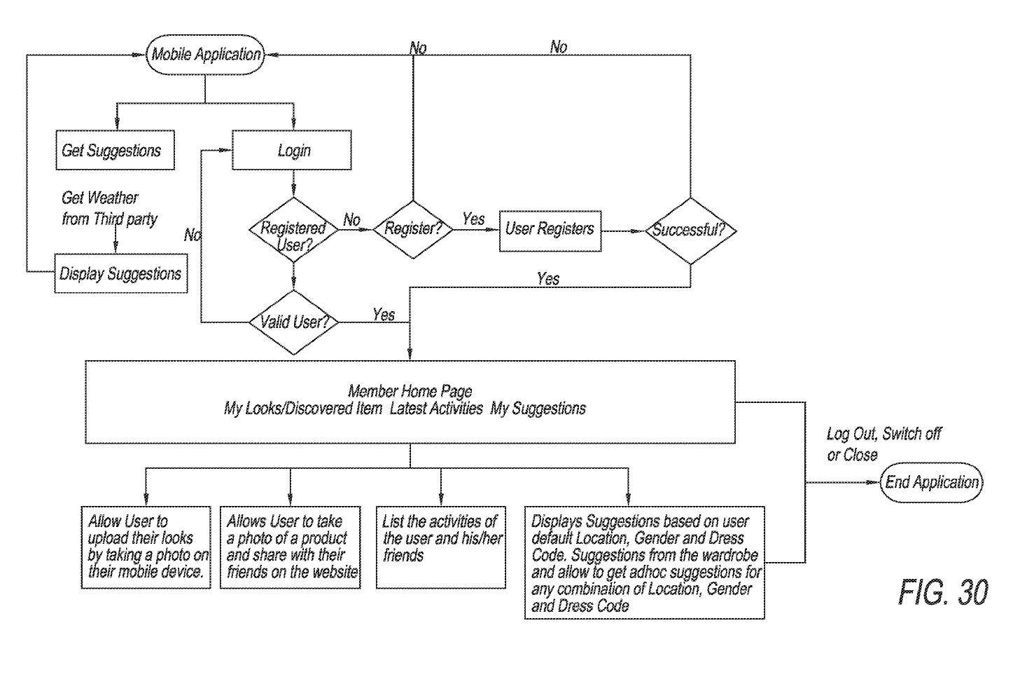

Still further, and referring now to FIG. 30, in a preferred embodiment mobile functionality is provided by enabling a user of a mobile device to take a photo from the device and share it with friends to upload their looks, outfit or a fashion product that they would like to share.

Embodiments of the invention further allow a data collection mechanism to determine the user location, types of fashion products a user likes, user's favorite brands and products in user's wish list. For example, a user may also appoint a personal shopper, provided for example, through the site, who buys items in the wish list. The collected data may also be used by fashion companies for targeted marketing and advertisers can advertise products that are tailored for a user's profile. Still further, a base is provided for new and upcoming designers to showcase, advertise and sell their creation without creating and maintaining the website on their own. Preferably a consolidated view of products offered by multiple customers to our users based on current necessities is provided. Users no longer have to go to multiple websites to select an item of purchase. This is possible as the website provides users multiple brands of clothes on the same page based on the user's profile and thus tailored to their desires and/or the site's suggestions. This provides users with an advantage of more choices for their money and at the same time fashion ideas.

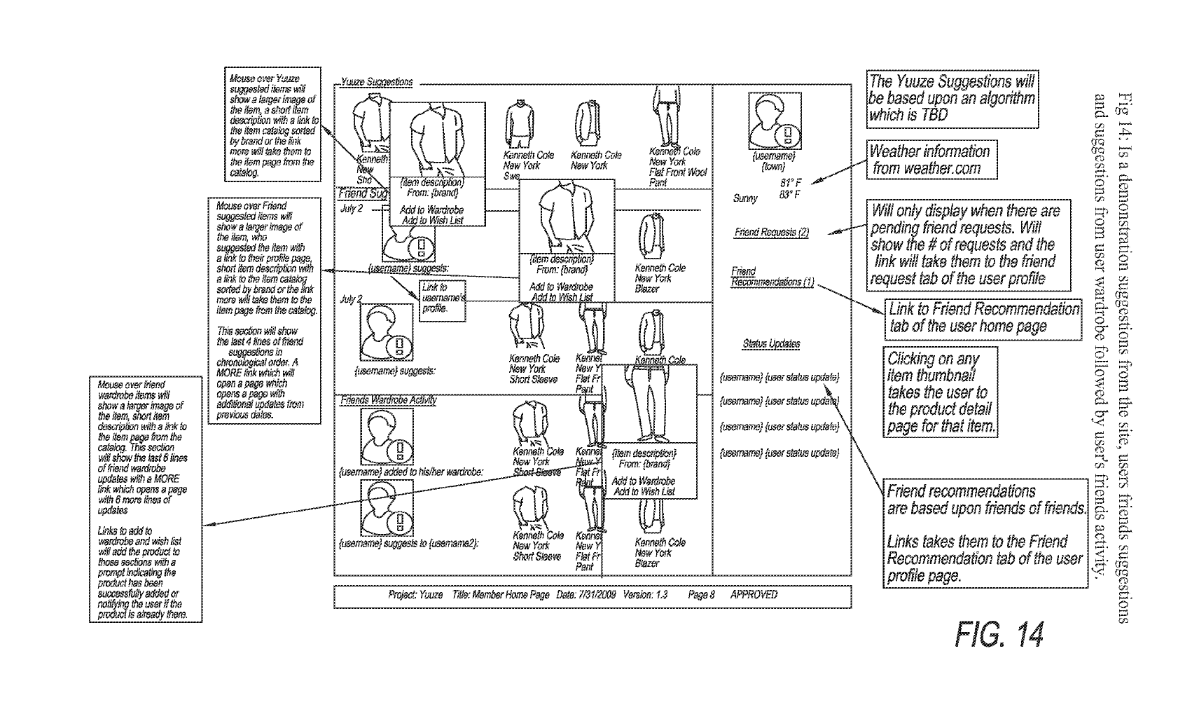

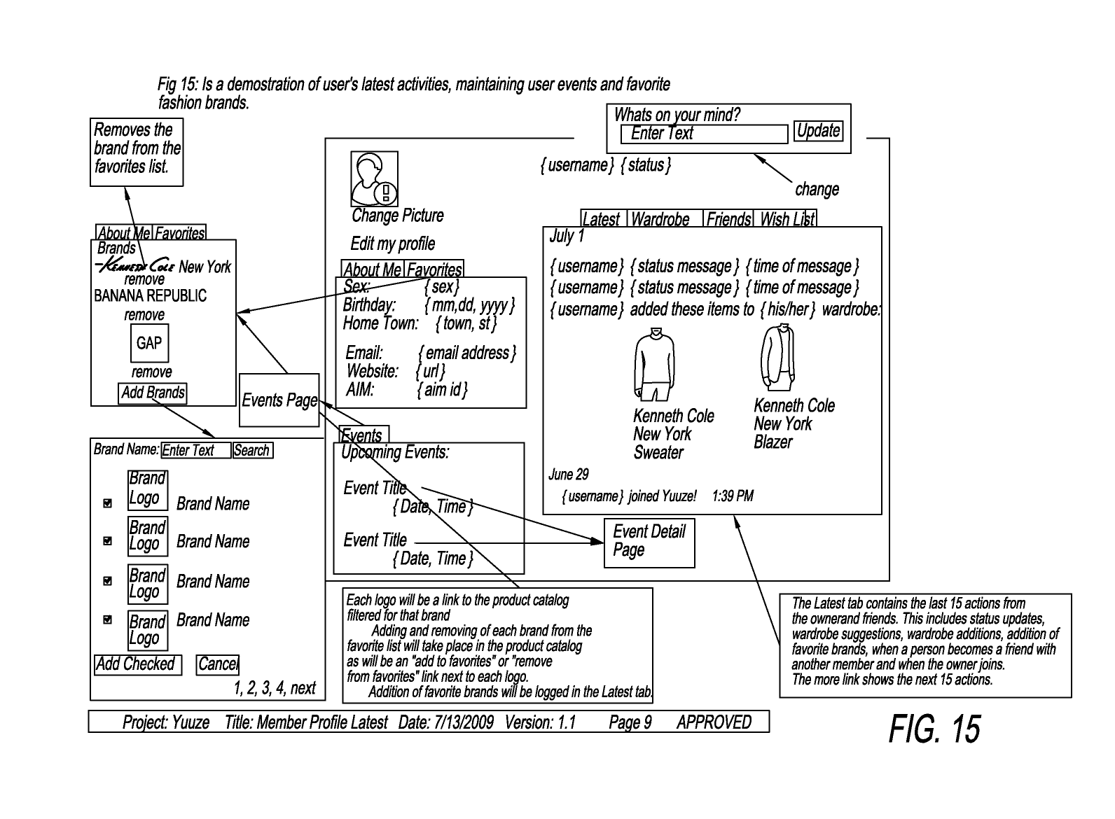

Referring now to FIG. 14, embodiments of the invention provide an answer to basic questions like: what to wear? what do my friends think about my outfit?, what is latest fashion?, what should I wear from my wardrobe?, and what would my friends like me to wear?. Users receive suggestions from the latest fashion, suggestions from friends and suggestion from wardrobe to make the decision on what to wear very easy. The suggestions (FIG. 14) assist user to formulate an outfit.

In another embodiment a platform for buying, selling and exchanging fashion products is provided. A user may choose to sell or exchange a product from their wardrobe. A designer may choose to characterize their collection to be suggested and sold.

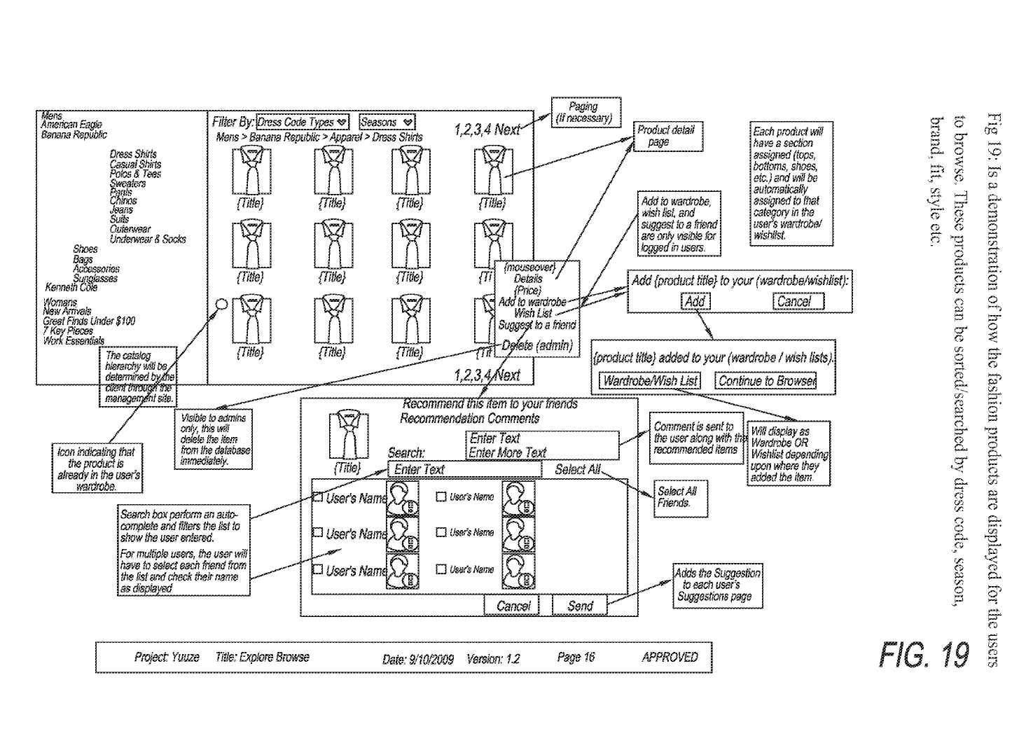

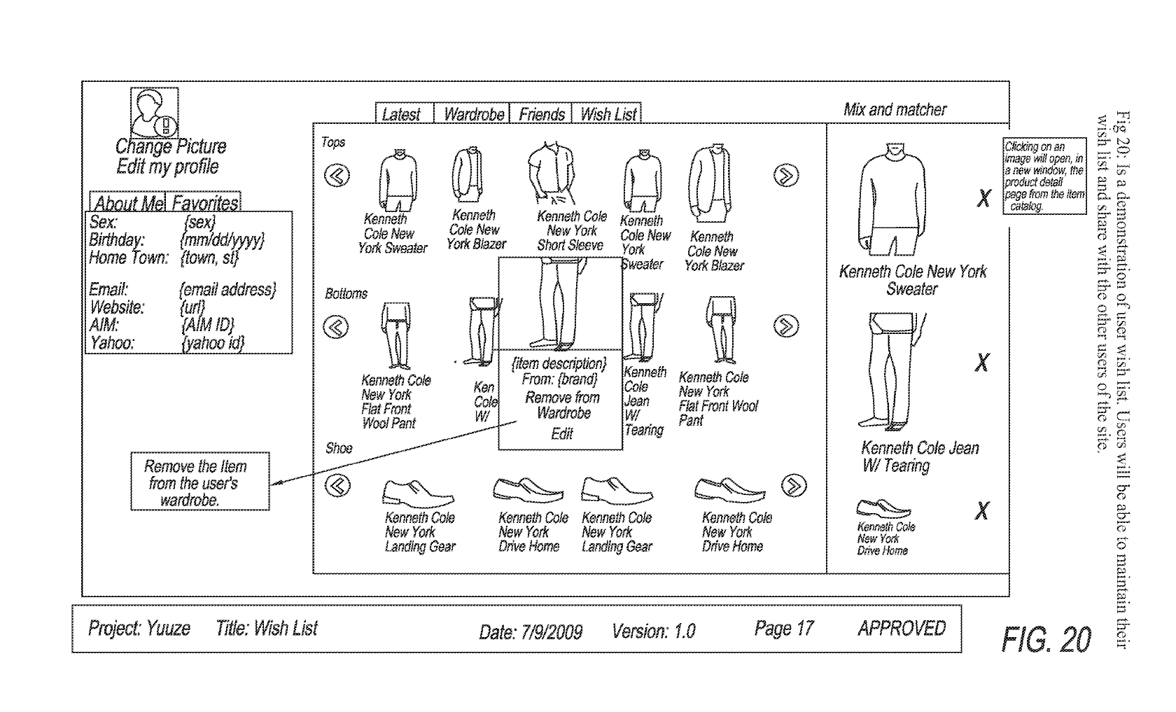

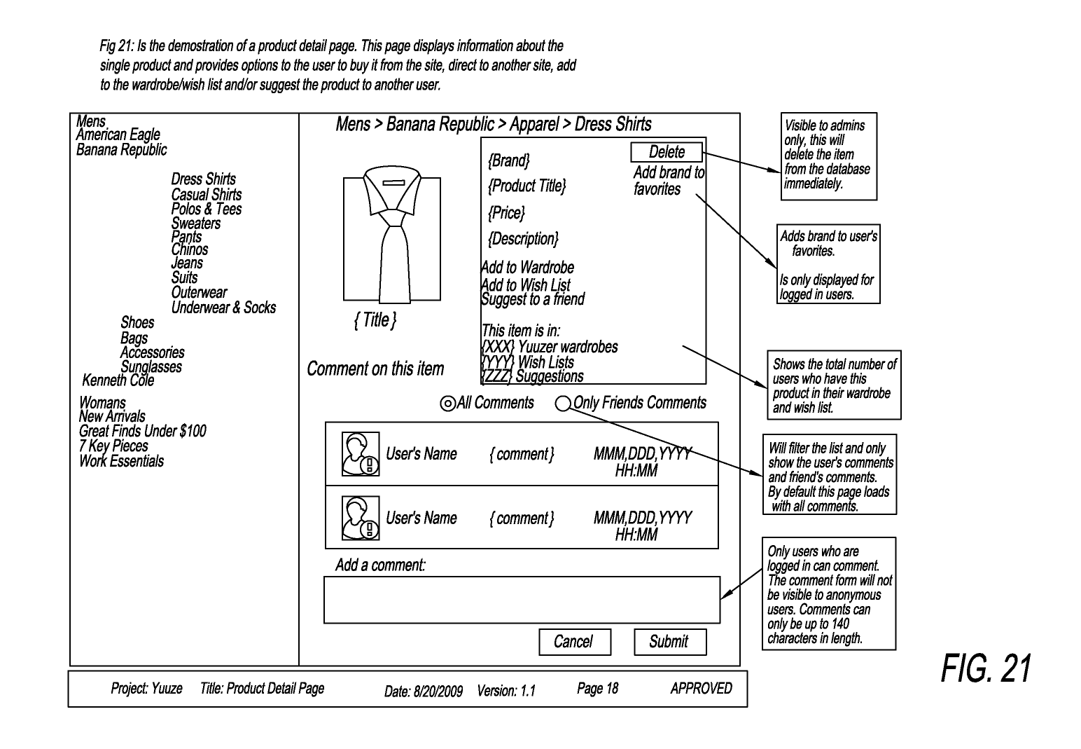

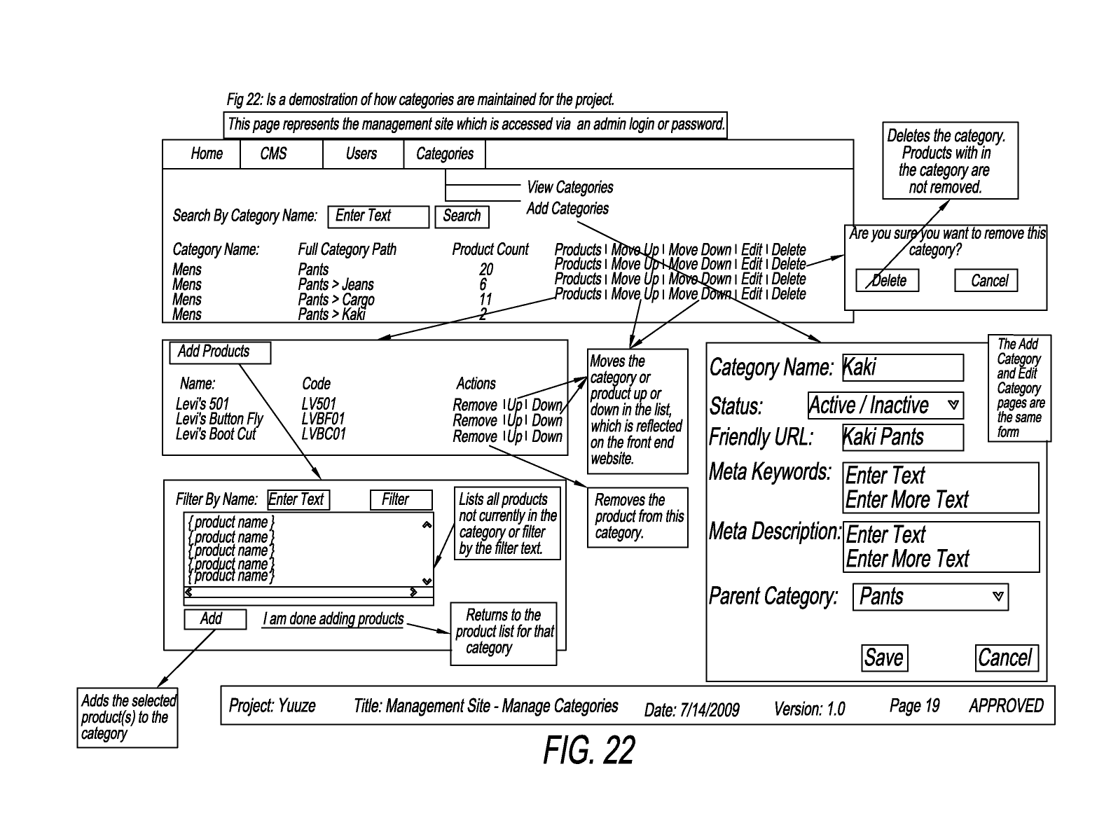

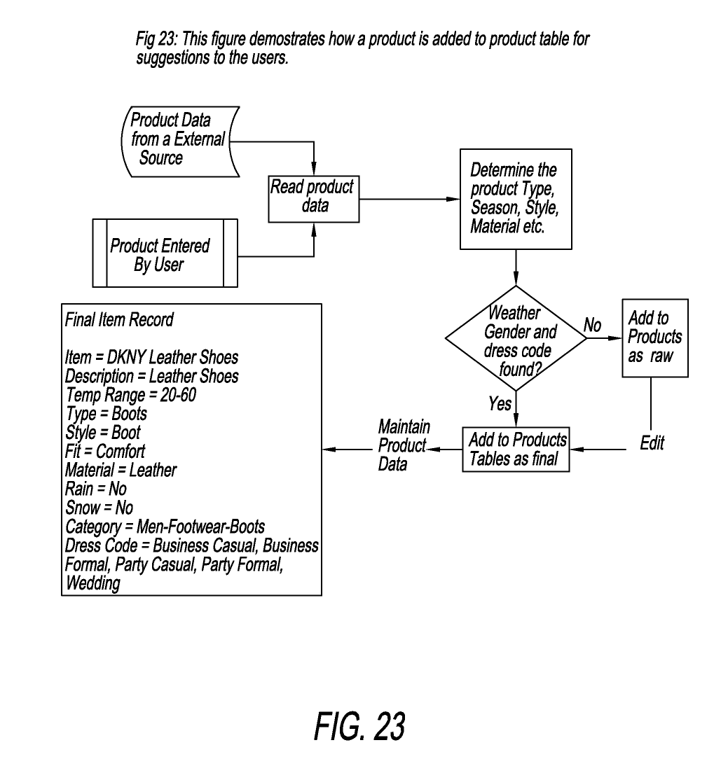

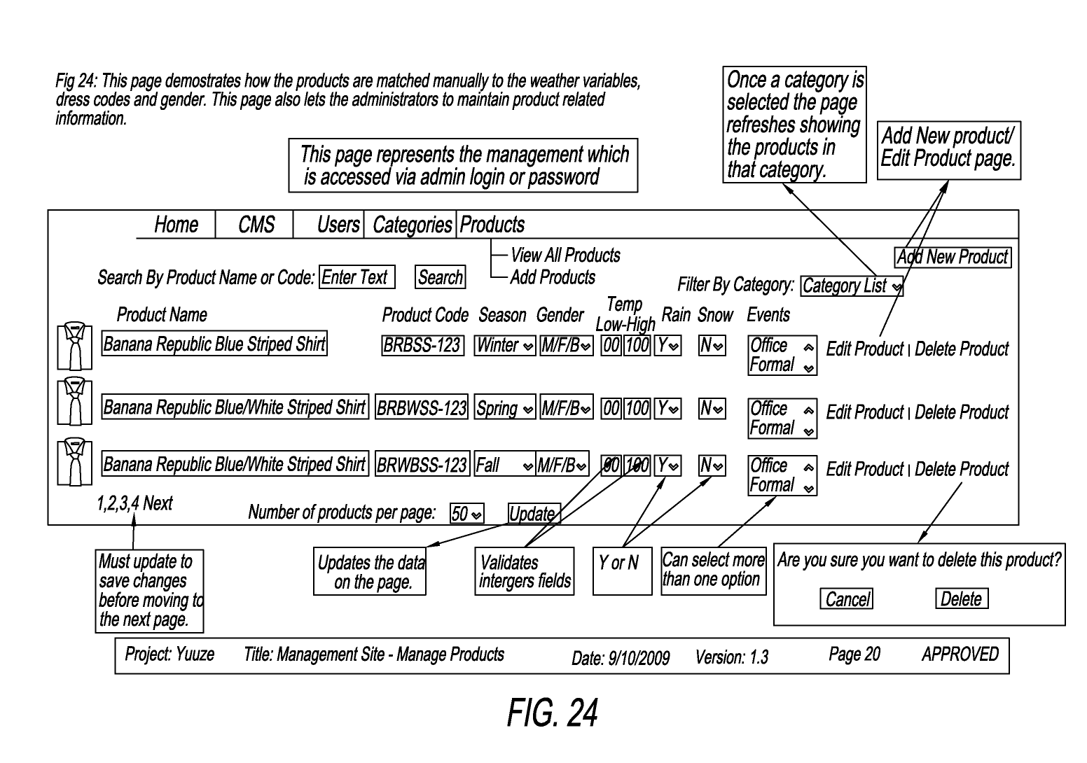

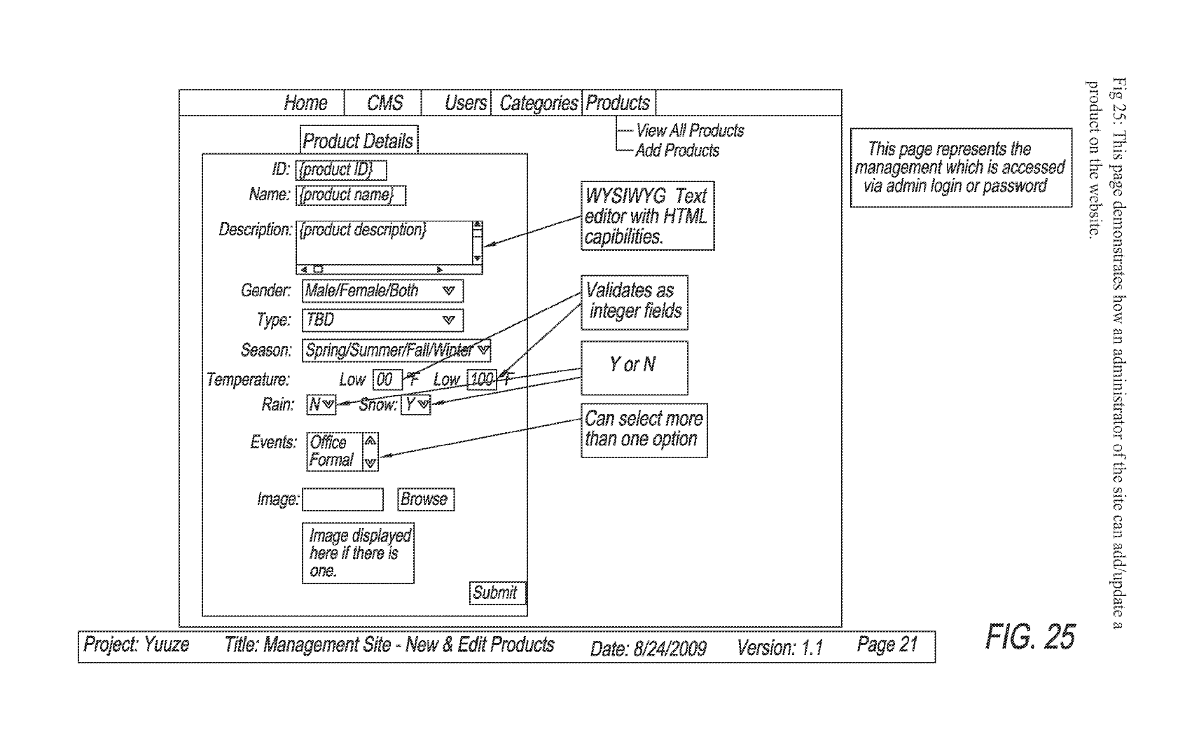

Still further, embodiments of the present invention provide extensive browse functionality where a user is able to search the catalog using multiple search criteria. Browse page (FIG. 19) has the ability to allow viewing of product details, add an item to the wardrobe, suggest it to friends and also look at product popularity by looking at the statistics of the product. Users have ability to go to a vendor website for further details or to buy a product. Users will also be able to buy product from the website itself Preferably, users can search using Categories of product, Gender, Style, Fit, Color, Type, Material, Dress Code, Season, Product Listing.

1. A method comprising:
(a) inputting selection criteria related to a clothing or accessory product,
(b) inputting selection criteria related to geographic location,
(c) processing the inputs of steps a and b to produce a score,
(d) selecting a clothing or accessory product based upon the score and
(e) displaying the clothing or accessory product.

2. The method of claim 1 wherein the selection criteria related to geographic location is selected from the group consisting of variables for temperature range, wind, humidity and precipitation.

3. The method of claim 1 wherein the selection criteria related to a clothing or accessory product comprises variables for one or more dress codes.

4. The method of claim 1 wherein the amount of time it takes a user to decide upon an outfit is reduced.

5. The method of claim 1 wherein selection criteria related to a clothing or accessory product comprises variables relating to an individual's fashion preferences.

6. A method comprising:
(a) uploading a user's wardrobe to a social networking website
(b) displaying said user's wardrobe to a social network composed of members
(c) receiving feedback from said social network.

7. The method of claim 6 wherein the feedback is based upon an event associated with the user's wardrobe.

9. The method of claim 7 wherein the social network shares items selected from each user's wardrobe with other members of the social network.

10. The method of claim 6 wherein a user's wardrobe comprises items which may be offered for sale or trade on a social networking website.

11. A system comprising:
(a) a database which stores fashion items and associated selection criteria
(b) a user interface which accepts user input selection criteria
(c) a first software module which uses user input selection criteria to obtain weather data for a geographic location
(d) a second software module which processes user input selection criteria and weather data to generate a series of scores
(d) a third software module which selects a fashion item based upon the series of scores, and
(e) a display device which displays the fashion item.

12. A system comprising:
(a) a database which stores user wardrobes
(b) a first software module which displays a user wardrobe to a social network
(c) a second software module which adds variables to fashion items within a user wardrobe
(d) a third software module which receives and displays feedback from the social network wherein said feedback is appended to fashion items present in a user wardrobe.

13. The system of claim 12 wherein the variable added comprises an event where the fashion item is proposed to be worn.

14. The system of claim 12 wherein the variable added comprises an offer to sell or trade the fashion item.
